(19) United States
(12) Patent Application Publication
(10) Pub. No.: US 2012/0191311 A1
(43) Pub. Date: Jul. 26, 2012

(54) METHOD AND APPARATUS FOR AIDING A DRIVER TO PARK A VEHICLE

(75) Inventors: Ajey Avinash Mohile, West Bloomfield, MI (US); Graham Scott Russell, Clarkston, MI (US); Bo Ye, Rochester Hills, MI (US); Scott Meoak, Troy, MI (US)

(73) Assignee: CONTINENTAL AUTOMOTIVE SYSTEMS, INC., AUBURN HILLS, MI (US)

(21) Appl. No.: 13/013,940

(22) Filed: Jan. 26, 2011

(51) Int. Cl. B60W 10/18; B60W 10/10

(52) U.S. Cl. 701/70; 192/219.2

(57) ABSTRACT

In order to avoid a sudden jerk when a vehicle is parked on a slope and its parking pawl engages with a toothed wheel on the transmission output shaft, a method is performed that detects that the vehicle's gear selector has been put into its parking mode and then gradually reduces the brake force until the vehicle starts moving. If the vehicle stops, the brake force will slowly be further reduced until the vehicle has reached its final position.

### FIELD OF THE INVENTION

The present invention relates to a method and apparatus aiding a driver to park a vehicle having a transmission with a parking pawl.

### BACKGROUND OF THE INVENTION

Vehicles with automatic transmissions are typically equipped with a parking pawl. The parking pawl engages a slot on a toothed wheel on the vehicle's transmission output shaft when the transmission mode selector is put into its parking mode for locking the driven wheels. Depending on the number of teeth on the toothed wheel, the output shaft may make up to one-eighth of a rotation before the parking pawl engages with the toothed wheel. Consequently, a vehicle parked on a slope may roll six inches or more before the parking pawl locks the transmission. The rolling vehicle may stop with a sudden jerk when the parking pawl engages the slot. Not only may this abrupt stop irritate the vehicle's occupants, the significant force exerted on the parking pawl may damage the toothed wheel or the parking pawl itself.

It is the objective of the present invention to reduce the sudden force exerted on the parking pawl when a vehicle is parked on a slope.

It is a further objective of the present invention to diminish the jerk perceived by the vehicle occupants when the parking pawl engages the slot on the toothed wheel when the vehicle is parked on a slope.

### SUMMARY OF THE INVENTION

These objectives are achieved by holding the vehicle brakes engaged after the driver releases the brake actuator and slowly reducing the brake force until the vehicle starts moving. Such a gradual release of the brakes allows the vehicle to move until the parking pawl engages, but it prevents the vehicle from freely accelerating pursuant to the downgrade force of the slope. Accordingly, the vehicle will not obtain a high speed that would result in a sudden jerk. Due to the lower speed, the force acting on the parking pawl is also reduced compared to a vehicle allowed to roll freely until the parking pawl engages.

According to the invention, the system can estimate a holding brake force sufficient to keep the vehicle immobilized on the slope. When the vehicle has stopped on the slope, the system can reduce the brake force to the holding brake force when the vehicle driver releases the brake pedal. Because the holding brake force will hold the vehicle on the slope, the slow reduction of brake force can start at the level of the holding brake force.

If the vehicle has an active suspension, it can first be allowed to settle, e.g. to lower the chassis or to vent air springs, before the brake force is reduced. That way, there will not be any other interfering operations while the method is performed.

While the brake force may be reduced continuously, using incremental steps may make the control easier to handle: The brake force remains at a certain level to observe whether the vehicle starts to move before the force is further reduced.

Once the system determines that the vehicle has reached its final position, it terminates the method by reducing the brake force to zero.

### BRIEF DESCRIPTION OF THE DRAWINGS

In the drawings,

FIG. 1 shows a schematic drawing of a parking pawl mechanism,

FIG. 2 shows a diagram of the forces acting on a vehicle on a slope when coming to a stop, and

FIG. 3 shows and example of the brake force and the vehicle speed over time while the method of the present invention is applied.

### DETAILED DESCRIPTION OF THE DRAWINGS

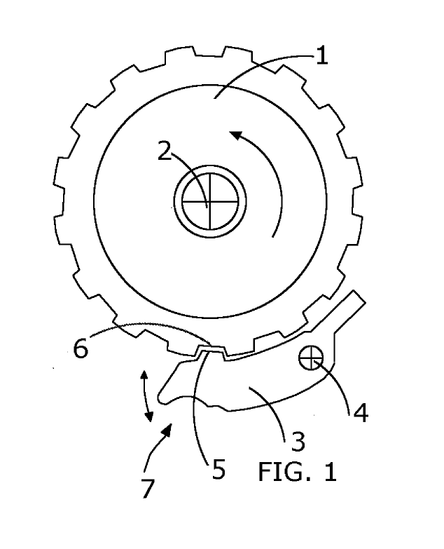

FIG. 1 shows a representative arrangement of a parking pawl mechanism. A toothed wheel 1 is rigidly connected to a transmission output shaft 2. In the present example, the toothed wheel has sixteen teeth separated by sixteen slots, but the number varies among vehicle makes and models. A parking pawl 7 comprises a parking pawl lever 3 arranged to swivel around a hinge 4. A tooth 5 on the parking pawl lever 3 is shaped in a way that, if the parking pawl lever 3 swivels toward the toothed wheel 1, the tooth 5 engages with a slot 6 on the toothed wheel 1. The parking pawl 7 is equipped with a bias spring (not shown) that urges the parking pawl lever 3 toward the toothed wheel 1.

While a vehicle is in a driving mode in which the vehicle may move, the parking pawl 7 is held in a position where the tooth 5 is removed from the slot 6 so that the transmission output shaft 2 can move freely.

When the vehicle is parked, the vehicle's gear selector (not shown) is moved to “P,” the parking mode, and the parking pawl 7 is released. The tooth 5 may not immediately match up with a slot and may come to rest on a tooth instead of a slot of the toothed wheel 1.

When the vehicle is parked on a level surface, the tooth 5 will remain on the toothed wheel 1 where it came to rest. But when the vehicle is parked on an uphill or downhill slope, it can accelerate in the slope's downward direction until the tooth 5 engages the next slot 6. Depending on the number of teeth on the toothed wheel 1 and on the initial resting position of the tooth 5, the distance the vehicle rolls can be six inches or more. On a steep slope, the vehicle can reach a speed that results in a noticeable jerk when the tooth 5 latches into the next slot 6 and abruptly stops the movement. This sudden stop can have a startling effect on the vehicle occupants and might over time cause damage to the tooth 5 or the teeth of the toothed wheel 1.

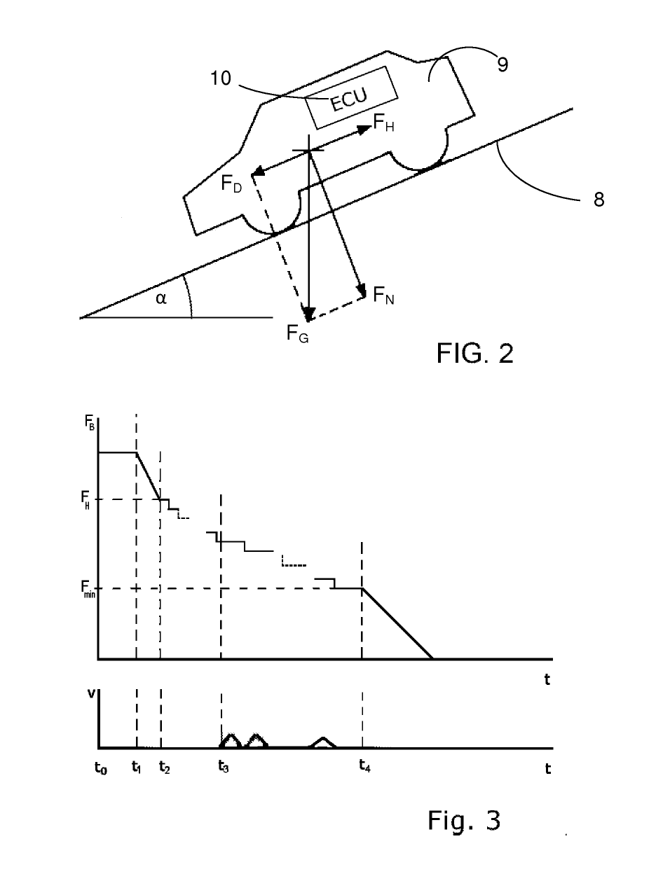

FIG. 2 shows the forces at work when a vehicle is brought to a stop on a slope before the parking pawl engages. While the schematic vehicle 9 is shown to face downhill, the same considerations apply when a vehicle faces uphill.

Vehicle 9 rests on a slope 8 with an inclination angle α. Gravity acts vertically downward on the vehicle with the gravitational force F_{G}. The gravitational force can be broken down into two vector components: the normal force F_{N} perpendicular to the surface or the slope and the downward force F_{D} parallel to the surface of the slope. The downward force F_{D} is in a linear correlation with the vehicle mass and with the sine of the inclination angle α—if friction forces are neglected.

In order to keep the vehicle from rolling downhill before the parking pawl engages, a holding brake force F_{H} countering the downward force must be applied. The magnitude of the brake force must be equal to the downward force.

The type of brake system used determines which physical quantity is manipulated to vary the brake force. In a hydraulic brake system, it is the pressure acting on a brake piston. But in an electrical brake, the quantity is the electrical current generating a magnetic field.

The following example of FIG. 3 can, for example, be directly translated to a hydraulic brake system by replacing the forces F_{H} and Fₘᵢₙ with hydraulic wheel brake pressure values that will generate brake forces corresponding to F_{H} and Fₘᵢₙ.

FIG. 3 shows the brake force (F_{B}) over time (t). At time t₀, the vehicle driver puts the gear selector into the parking mode. Initially, an electronic controller (ECU) 10 controls the vehicle's brake system to maintain the brake force prevailing at the time at which the parking mode was selected. This delay allows the vehicle to settle down for parking, which may include venting an air spring system or lowering a different kind of suspension. Then the electronic controler checks whether the vehicle driver has released the manual brake actuator, usually a brake pedal.

Assuming this has occurred by time t₁, the brake force is lowered in one step to a holding force F_{H}, which is reached at time t₂. This holding brake force F_{H} corresponds to the holding brake force F_{H} of FIG. 2. The holding brake force F_{H} is a force that, at the current inclination angle α and vehicle gravitational force F_{G} will keep the vehicle 9 immobilized on the slope. The two required quantities, inclination angle α and vehicle gravitational force F_{G}, not to mention other forces like wind or friction, may not be precisely known. Therefore, the holding brake force F_{H} may have to be approximated. The brake force F_{B} should be able to compensate the highest possible downward force F_{D}. But even if the estimate is slightly too low, the vehicle 9 would start to move slowly down the slope—at most until the tooth 5 of the parking pawl 7 engages the next available slot 6.

Now, assuming that the holding force F_{H} was properly chosen and the vehicle 9 has not started to move, the brake force F_{B} is lowered in small increments until the vehicle 9 starts rolling and the vehicle speed v has a value other than zero at a time t₃. If the vehicle 9, after starting to move, slows down to a stop again, the brake force F_{B} can be incrementally lowered further. This is done to make sure that the vehicle 9 has not just stopped because of an uneven road surface or some other unrelated impediment. The process of lowering the brake force until the parking pawl 7 has engaged the toothed wheel 1 can take several seconds, depending on the distance the vehicle 9 travels until the tooth 5 catches in slot 6.

But if the vehicle 9, despite lowered brake force, does not start moving again, the system assumes that the parking pawl has engaged with the toothed wheel. This determination can be based on several factors, alternatively or concurrently. Such factors include but need not be limited to:

Brake force difference or ratio between the last movement and now;

Lapse of time;

Absolute present brake force F_{B}; and

Distance traveled by vehicle 9 since the gear selector was put in the parking mode.

Once the electronic controller 10 determines that the parking pawl 7 is engaged, it can direct the vehicle's brake system to release the brake force. The vehicle 9 may have an automatic parking brake that can take over before the brake force is released.

In a vehicle 9 with a non-hydraulic brake system, a parking brake function may be performed by the operating brake. In such vehicles, the brake force might not be reduced any further at all after the parking pawl engages the toothed wheel.

The above represents only one example of implementing the method to avoid a sudden stop when parking a vehicle on a slope. The method relies on a gradual brake force reduction, which may occur in steps as shown or on a continuous curve. The slope of the continuous curve, just as the height and duration of each incremental step can be optimized for time (steeper curve, greater increments and shorter time intervals) or for comfort (less steep curve, smaller increments, longer time intervals). The parameters for optimizing the method can be empirically determined.

Also, initially lowering the brake force to an estimated holding force (or holding pressure) will accelerate the completion of the process.

The broad teachings of the disclosure can be implemented in many ways not specifically pointed out. Accordingly, the true scope of the disclosure is not limited to the particular examples discussed in detail. Further modifications become apparent by studying the drawings, the specification, and the following claims.

1. A method of aiding a vehicle driver to park a wheeled vehicle on a slope, the vehicle being equipped with a parking pawl and having a brake system configured to apply vehicle brakes without the driver operating a brake actuator, the method comprising the steps of
detecting that a gear selector has been put into a parking mode;
keeping the vehicle brakes applied with an initial brake force,
detecting that the brake actuator has been released, and
reducing the brake force over time until the vehicle starts moving.

2. The method of claim 1, further comprising the steps of
estimating a holding brake force sufficient to keep the vehicle immobilized on the slope, and
reducing the brake force in one step to the holding brake force.

3. The method of claim 1 for a vehicle with an active suspension, wherein the brake force is only reduced after the active suspension has settled for parking.

4. The method of claim 1, wherein the the brake force is reduced in incremental steps.

5. The method of claim 4, wherein the brake force of every incremental step is maintained until the vehicle stops moving.

6. The method of claim 1, further comprising the steps of
determining that the vehicle is not going to move any further while the gear selector remains in the parking mode, and
setting the brake force to a final value.

7. The method of claim 6, wherein the final value equals zero.

8. The method of claim 6, wherein the final value is a brake force calculated to keep the vehicle immobilized on the slope, even without a parking pawl.

9. A vehicle equipped with
a gear selector including a parking mode that cooperates with a parking pawl,
a brake system configured to apply vehicle brakes without an actuation of a driver-operated brake actuator, and
an electronic controller programmed to cooperate with the brake system to perform the following steps:
detecting that the gear selector has been put into a parking mode;
keeping the vehicle brakes applied with an initial brake force,
detecting that a driver has released the brake actuator, and
gradually reducing the brake force until the vehicle starts moving.

10. An electronic controller comprising:
a control program to cooperate with a brake system configured to apply vehicle brakes without actuation of a driver-operated brake actuator, wherein the control program comprises instructions for:
detecting that a gear selector which is connected to a parking pawl for the vehicle is in a parking mode position;
determining an intial brake force to be applied to the vehicle brakes;
instructing the brake system to apply the vehicle brakes with the initial brake force;
detecting that the brake actuator for the vehicle has been released; and
instructing the brake system to gradually reduce the brake force until the vehicle starts moving.
